(19) United States
(12) Patent Application Publication
(10) Pub. No.: US 2013/0031144 A1
(43) Pub. Date: Jan. 31, 2013

(54) SYSTEMS AND METHODS FOR CREATING SUPPORT CASES IN A MULTI-TENANT DATABASE SYSTEM ENVIRONMENT

(71) Applicants: Rajasekar Elango, San Francisco, CA (US); Ben Zimmerman, San Francisco, CA (US); Denise Glaser, San Francisco, CA (US)

(72) Inventors: Rajasekar Elango, San Francisco, CA (US); Ben Zimmerman, San Francisco, CA (US); Denise Glaser, San Francisco, CA (US)

(73) Assignee: SALESFORCE.COM, INC., San Francisco, CA (US)

(21) Appl. No.: 13/369,944

(22) Filed: Feb. 9, 2012

Related U.S. Application Data
(60) Provisional application No. 61/511,767, filed on Jul. 26, 2011.

(51) Int. Cl. G06F 7/00

(52) U.S. Cl. 707/805; 707/802; 707/E17.044; 707/E17.032

(57) ABSTRACT

A system and method are provided for creating a support case object in a multi-tenant database environment. The method, for example, may include receiving, by a support case manager on a multi-tenant database server, information related to an infrastructure event in the multi-tenant database environment, creating, by the support case manager, the support case based upon the received information, and associating, by the support case manager, the support case with the infrastructure event.

### CROSS-REFERENCE TO RELATED APPLICATION(S)

This application claims the benefit of U.S. provisional patent application Ser. No. 61/511,767, filed Jul. 26, 2011, the entire content of which is incorporated by reference herein.

### TECHNICAL FIELD

The following relates to data processing systems and processes, and more particularly relates to systems and processes for creating support cases in a multi-tenant database system environment.

### BACKGROUND

Modern software development is evolving away from the client-server model toward “cloud”-based processing systems that provide access to data and services via the Internet or other networks. In contrast to prior systems that hosted networked applications on dedicated server hardware, the cloud computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Although multi-tenant platforms can provide substantial benefits, they can be relatively difficult to design and develop. The often competing demands of integration and isolation between tenants, for example, can lead to any number of challenges in design and implementation. For example, multiple tenants share a common server. Accordingly, in the rare instances when there is an infrastructure event affecting the multi-tenant database network, multiple tenants may be affected.

### DESCRIPTION OF THE DRAWING FIGURES

Exemplary embodiments will hereinafter be described in conjunction with the following drawing figures, wherein like numerals denote like elements, and

FIG. 1 is a block diagram of an exemplary multi-tenant data processing system;

FIG. 2 illustrates an exemplary user interface for creating support cases, in accordance with an embodiment;

FIG. 3 is a flow diagram illustrating a method for creating and updating support cases in accordance with an embodiment; and

FIG. 4 illustrates the exemplary user interface illustrated in FIG. 2 after a support case has been created.

### DETAILED DESCRIPTION

According to various exemplary embodiments, systems and methods are provided for creating support cases a multi-tenant database environment. In the rare instance that an infrastructure event occurs which affects the multi-tenant database environment, multiple tenants could be affected. Accordingly systems and methods are provided which allow users to easily create support cases from a single-click process while also preventing multiple support cases from being created for the same infrastructure event.

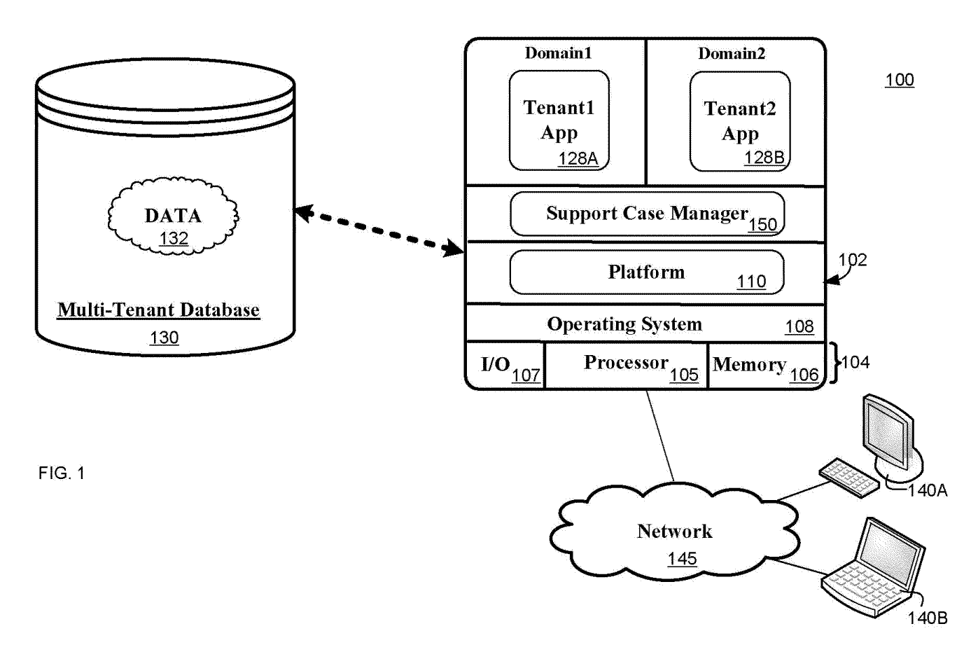

Turning now to FIG. 1, an exemplary multi-tenant application system 100 suitably includes a server 102 that dynamically creates virtual applications 128A-B based upon data 132 from a common database 130 that is shared between multiple tenants. Data and services generated by the virtual applications 128A-B are provided via network 145 to any number of client devices 140A-B, as desired. Each virtual application 128A-B is suitably generated at run-time using a common platform 110 that securely provides access to data 132 in database 130 for each of the various tenants subscribing to system 100. Each virtual application 128A-B may be accessible via a unique domain. For example, the virtual application 128A may be accessible on a first domain (e.g., http://www.companyname1.salesforce.com) and the application 128B may be accessible on a second domain (e.g., http://www.companyname2.com). The virtual applications 128A-B may be used, for example, by the various tenants to create and manage data or reports based upon data 132 in the common database 130. The server 102 also includes a support case manager 150 for creating and managing support cases, as discussed in further detail below. While in the embodiment illustrated in FIG. 1 illustrates a single server 102, the functionality of the server 102 need not be found in a single piece of hardware as shown, but could be distributed among a plurality of server machines.

A “tenant” generally refers to a group of users that shares access to common data within database 130. Tenants may represent customers, customer departments, business or legal organizations, and/or any other entities that maintain data for particular sets of users within system 100. Although multiple tenants may share access to a common server 102 and database 130, the particular data and services provided from server 102 to each tenant can be securely isolated from those provided to other tenants. The multi-tenant architecture allows different sets of users to share functionality without necessarily sharing each other's data 132.

Database 130 is any sort of repository or other data storage system capable of storing and managing data 132 associated with any number of tenants. Database 130 may be implemented using any type of conventional database server hardware. In various embodiments, database 130 shares processing hardware 104 with server 102. In other embodiments, database 130 is implemented using separate physical and/or virtual database server hardware that communicates with server 102 to perform the various functions described herein.

Server 102 is implemented using one or more actual and/or virtual computing systems that collectively provide a dynamic application platform 110 for generating virtual applications 128A-B. Server 102 operates with any sort of conventional computing hardware 104, such as any processor 105, memory 106, input/output features 107 and the like. Processor 105 may be implemented using one or more of microprocessors, microcontrollers, processing cores and/or other computing resources spread across any number of distributed or integrated systems, including any number of “cloud-based” or other virtual systems. Memory 106 represents any non-transitory short or long term storage capable of storing programming instructions for execution on processor 105, including any sort of random access memory (RAM), read only memory (ROM), flash memory, magnetic or optical mass storage, and/or the like. Input/output features 107 represent conventional interfaces to networks (e.g., to network 145, or any other local area, wide area or other network), mass storage, display devices, data entry devices and/or the like. In a typical embodiment, application platform 110 gains access to processing resources, communications interfaces and other features of hardware 104 using any sort of conventional or proprietary operating system 108. As noted above, server 102 may be implemented using a cluster of actual and/or virtual servers operating in conjunction with each other, typically in association with conventional network communications, cluster management, load balancing and other features as appropriate.

The support case manager 150 interacts with the virtual tenant applications 128A-B. When an infrastructure event occurs, the event may be logged by one of the virtual tenant applications 128A-B. In one embodiment, for example, one of the virtual tenant applications 128A-B may be an application dedicated to monitoring the multi-tenant database infrastructure. In another embodiment, for example, a virtual tenant application 128A-B may have an event console tracking infrastructure events associated with the tenant application. The infrastructure events may include, but are not limited to, network disruption event, server status events, hard drive status events and any other event which affected the multi-tenant database system environment in some detectable way. In this regard, a detectable infrastructure event may impact or influence only one tenant application supported by the server 102, all of the tenant applications supported by the server 102, or some (but not all) of the tenant applications supported by the server 102. In practice, an infrastructure event is detected, discovered, or determined by an infrastructure monitoring application. Accordingly, there could be a predefined set of infrastructure events associated with the operation of the multi-tenant database system.

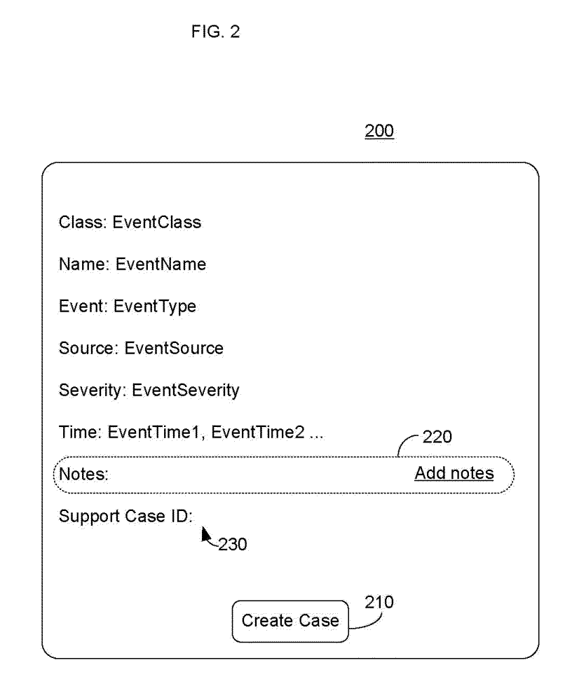

FIG. 2 illustrates an exemplary user interface 200 for creating support cases. In one embodiment, for example, the user interface 200 may be displayed as a web page. The user interface 200 may be displayed, for example, when a user opens an event in the event console. The user interface 200 displays details about an infrastructure event, including, but not limited to, a class of the infrastructure event, an event name, an event type, an event source, an event severity and an event time when the infrastructure event occurred or multiple times if the infrastructure event has occurred multiple times. The user interface 200 also includes a create case interface 210. When a user interacts with the create case interface 210, a support case is automatically created for the infrastructure event, as discussed in further detail below. In one embodiment, for example, a single click of the create case interface 210 can create the support case. One benefit of the single click interface to create the support case is that is simplifies the process of creating support cases for non-administrative users.

The support case requests that an administrator of the multi-tenant database system 100 follow-up on the infrastructure event. The user interface 200 also includes a notes interface 220 and a Support Case Identification interface 230. In one embodiment, for example, the notes interface 220 allows notes to be passed between the user requesting the support case to be created and an administrator working on the support case. The user, for example, can add notes to the notes interface before requesting the support case to be created. Furthermore, an administrator can also associate notes with the created support case which can be displayed in the notes interface 220, as discussed in further detail below.

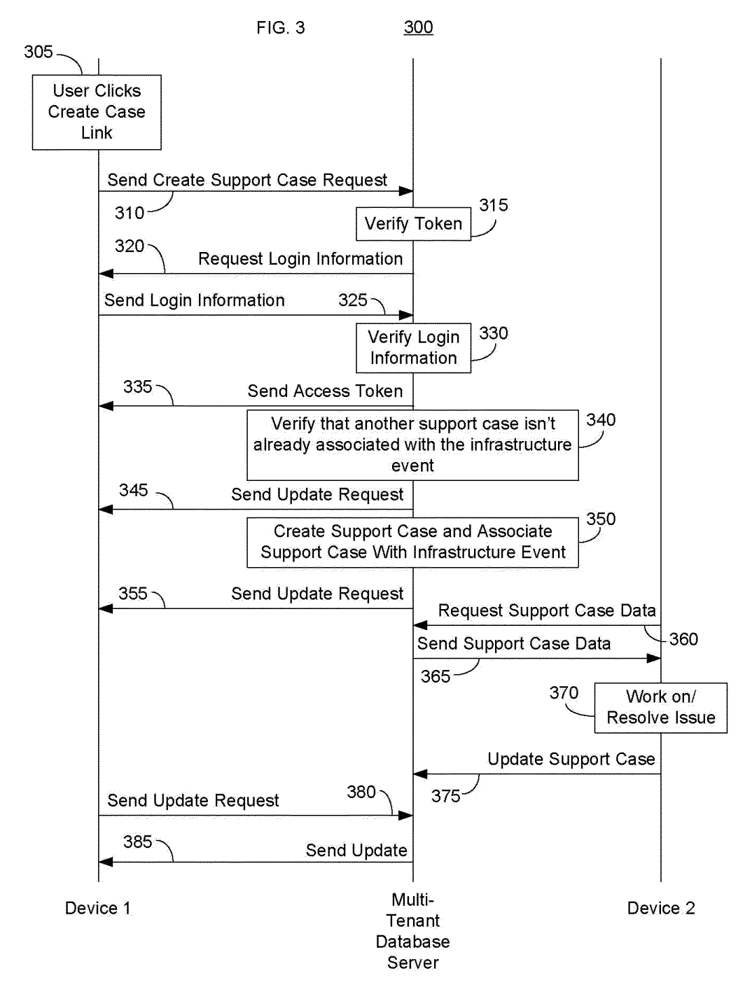

FIG. 3 is a flow diagram illustrating a method for creating and updating support cases 300 in accordance with an embodiment. The method 300 begins when a user interacts with a suitable user interface, such as the create case interface 210 illustrated in FIG. 2. (Step 305). When the user interacts with the user interface, a create support case request is sent (Step 310). For the exemplary embodiment described above, the request is sent to the support case manager 150 on the multitenant database system 100. The request may include the infrastructure event information as well as user login information, such as a token, if available, signifying that the user is authorized to request support cases.

Upon receiving the support case creation request, the process verifies that the user is authorized to submit support case creation requests. (Step 315). This verification may be performed by the support case manager 150. If a token was sent with the support case creation request, the process support case manager 150 verifies that the user has a valid token. In one embodiment, for example, this verification may be performed by the support case manager 150.

If a token wasn't transmitted with the support case creation request, the process sends a request to the user's device to have the user log in. (Step 320). In one embodiment, for example, the request causes a child window to open on the user's device with an authorization interface. After the user's credentials are entered, the tenant device sends the login information back to the multi-tenant database system 100. (Step 325). The process then verifies that the user's credentials are valid and that the user is permitted to request the creation of support cases. (Step 330). If the user's credentials are validated, the process sends a token to the user's device. (Step 335). Once login information is verified, the token could be stored in a user's session. Accordingly, in this embodiment, a user may only have to enter login information once and subsequent support case creation requests will work with a single click until the user session times out or the user logs out of the system.

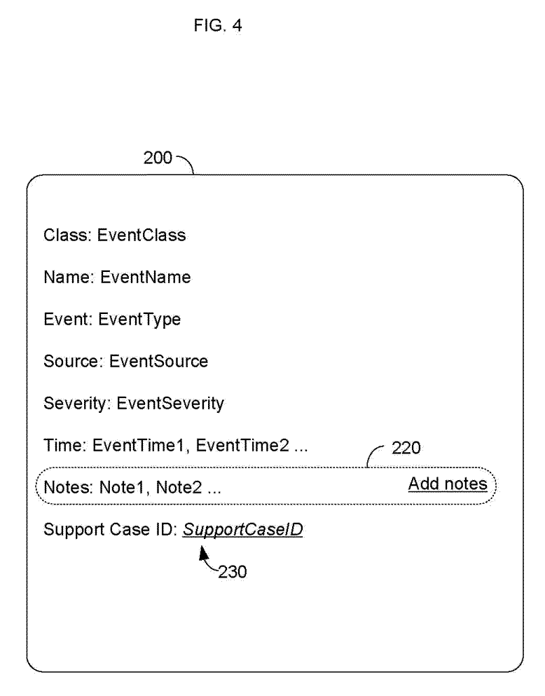

After the user's credentials have been verified, the process determines if a support case has previously been created for the infrastructure event. (Step 340). This process may be performed by the support case manager 150. In one embodiment, for example, the support case manager 150 compares the event class, event name, event type, event source, and/or the event time submitted with the create support case request to see if any existing support cases match. If a support case has already been created for the infrastructure event, the support case manager 150 sends a request to the user's device to update or refresh the user interface 200 illustrated in FIG. 2. (Step 345). FIG. 4 illustrates an exemplary user interface 200 after a support case has been created and the user interface has been refreshed. As seen in FIG. 4, the create case interface 210 illustrated in FIG. 2 no longer appears. Furthermore, the assigned support case identification number appears as well as any notes associated with the support case, as discussed in further detail below.

Returning to FIG. 3, if a support case was not previously created for the infrastructure event, the process creates the support case and associates the support case with the infrastructure event. (Step 350). In one embodiment, for example, the support case manager 150 may create the support case. When creating the support case, the process associates the support case with the infrastructure event and assigns support case data to the support case. The support case data may include, but is not limited to, an origin, a subject, a description of the infrastructure event, a priority for the support case, an incident data and/or time, a record type, identification of the hosts affected, impacts to data rates, the status of any hardware, an incident severity and any event notes. The event notes may include notes from the user creating the support case as well as any notes from the administrator. The process also creates the support case ID. The support case ID allows all users who wish to monitor the support case the ability to follow the status of the support case.

After the support case is created, the process sends a request to the user's device to update the user interface 200. (Step 355). As discussed above, FIG. 4 illustrates an exemplary user interface 200 after a support case has been created and the user interface has been refreshed. As seen in FIG. 4, the create case interface 210 illustrated in FIG. 2 no longer appears. Furthermore, the assigned support case identification number appears as well as any notes associated with the support case. In one embodiment, for example, the event notes interface 220 can include the event notes from the administrator. Accordingly, the user who created the support case and the administrator handling the support case can communicate via the notes interface. In one embodiment, for example, the support case ID is a hyperlink. When a user clicks on the hyperlink, the user can view all of the details of the support case.

Once the support case has been created, an administrator from another device can request for the support case data. (Step 360). The process, upon verification of the administrators credentials, transmits the support case data to the administrator's device. (Step 365). The administrator, after working on or resolving the issue (Step 370) can send an update to the multi-tenant database server. (Step 375). The update sent by the administrator can update the support case data. In one embodiment, for example, the administrator can include notes to be displayed in the notes interface 220 on the user interface 200. The notes synchronization can be bidirectional, such that after a case is created, if user adds a new note to event, the note will be automatically pushed to support case associated with event.

A user, at any time, can also send an update request to the multi-tenant database server. (Step 380). The update request may simply request that the user interface be updated, such as the user interface 200. In one embodiment, for example, a user could also add notes to the note interface 220. The user notes, for example, could ask a question for the administrator handling the support case, or give additional information that the administrator may need. In response to receiving the update request, the process updates the support case data, if notes were included in the update request, and then send the latest information on the support case to the user's device. (Step 385).

While the exemplary embodiments described herein illustrate a tenant application 128A-B interfacing with the support case manager 150, other non-multi-tenant based application running, for example, on client devices 140A-B could also be configured to interface with the support case manager 150 to create and monitor support cases.

Generally speaking, the various functions and features of method 300 may be carried out with any sort of hardware, software and/or firmware logic that is stored and/or executed on any platform. Some or all of method 300 may be carried out, for example, by logic executing within system 100 in FIG. 1. For example, various functions shown in FIG. 3 may be implemented using software or firmware logic that is stored in memory 106 and executed by processor 105 as part of application platform 110. The particular hardware, software and/or firmware logic that implements any of the various functions shown in FIG. 3, however, may vary from context to context, implementation to implementation, and embodiment to embodiment in accordance with the various features, structures and environments set forth herein. The particular means used to implement each of the various functions shown in FIG. 3, then, could be any sort of processing structures that are capable of executing software and/or firmware logic in any format, and/or any sort of application-specific or general purpose hardware, including any sort of discrete and/or integrated circuitry.

The term “exemplary” is used herein to represent one example, instance or illustration that may have any number of alternates. Any implementation described herein as “exemplary” should not necessarily be construed as preferred or advantageous over other implementations.

Although several exemplary embodiments have been presented in the foregoing description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A computer executed method for creating a support case object in a multi-tenant database environment, comprising:
receiving, by a support case manager on a multi-tenant database server from a tenant application on a user device, information related to an infrastructure event in the multi-tenant database environment;
creating, by the support case manager, the support case based upon the received information; and
associating, by the support case manager, the support case with the infrastructure event.

2. The method of claim 1, further comprising:
sending, by the support case manager, a user interface update request to the user device, wherein the user interface update request is configured to update a user interface displayed on the user device.

3. The method of claim 1, further comprising:
receiving, by the support case manager, an update for the support case from an administrative device; and
sending, by the support case manager, a user interface update request to the user device.

4. The method of claim 1, further comprising:
receiving, by the support case manager from the user device, user login information;
verifying, by the support case manager, that the user device is authorized to create a support case based upon the user login information.

5. The method of claim 1, wherein the creating further comprises:
verifying, by the support case manager, that other existing support cases are not associated with the infrastructure event.

6. The processing system of claim 1, wherein the creating further comprises creating a support case identification number for the support case.

7. The processing system of claim 1, wherein the creating further comprises associating a hyperlink with the support case.

8. A system for creating support cases in a multi-tenant database environment, comprising:
a computer-implemented server comprising a processor configured to:
receive, from a tenant application of the multi-tenant database environment, a request to create a support case related to an infrastructure event in the multi-tenant database environment;
verify that no other support case has been created for the infrastructure event;
create the support case; and
associate the support case with the infrastructure event.

9. The system of claim 8, wherein the processor is further configured to:
receive, from a tenant application of the multi-tenant database environment, user login information; and
verify that the tenant application is authorized to create support cases based upon the user login information.

10. The system of claim 8, wherein the processor is further configured to:
send an update request to a device running the tenant application, the update request updating a user interface on the device running the tenant application.

11. The processing system of claim 8, wherein the processor is further configured to:
receive a request for support case data from an administrative device;
send the support case data to the administrative device; and
receive update data for the support case data from the administrative device.

12. The processing system of claim 11, wherein the processor is further configured to update support case data based upon the update data.

14. The processing system of claim 8, wherein the infrastructure event is a network disruption.

15. The processing system of claim 8, wherein the processor is further configured to create a support case identification number for the support case.

16. The processing system of claim 8, wherein the processor is further configured to associate a hyperlink with the support case.

17. A method for creating a support case object in a multi-tenant database environment, comprising:
receiving, by a device configured to be in communication with a multi-tenant database server, a request to create the support case related to an infrastructure event in the multi-tenant database environment based upon a single click on a user interface displayed on the device;
sending, by the device, information on the infrastructure event to the multi-tenant database server.

18. The method of claim 17, further comprising:
sending, by the device, a token to the multi-tenant database server, the token indicating the device is authorized to create support cases.

19. The method of claim 17, further comprising:
sending, by the device, user notes on the infrastructure event to the multi-tenant database server if user notes were included in a notes interface displayed on the user device.

20. The method of claim 17, further comprising:
requesting, by the device, an update for the support case; and
receiving, by the device, the update for the support case from the multi-tenant database server.
